(19) United States
(12) Patent Application Publication
(10) Pub. No.: US 2025/0161816 A1
(43) Pub. Date: May 22, 2025

(54) RECORDING MEDIUM AND INFORMATION PROCESSING DEVICE

(71) Applicant: SEGA CORPORATION, Tokyo (JP)

(72) Inventors: Yoshiya Honda, Tokyo (JP); Koji Nakaso, Tokyo (JP)

(73) Assignee: SEGA CORPORATION, Tokyo (JP)

(21) Appl. No.: 19/033,904

(22) Filed: Jan. 22, 2025

Related U.S. Application Data
(63) Continuation of application No. PCT/JP2023/009358, filed on Mar. 10, 2023.

(30) Foreign Application Priority Data
Jul. 26, 2022 (JP) 2022-118747

(51) Int. Cl. A63F 13/63; A63F 13/92

(52) U.S. Cl. CPC A63F 13/63; A63F 13/92

(57) ABSTRACT

A non-transitory computer readable recording medium storing instructions for organizing a deck including setting boxes in which first contents available to a player are respectively set, the instructions causing an information processing device to execute: in response to a player operation, setting, as a locked content, at least one of the first contents in the setting boxes; removing, from the setting boxes, any first contents other than the locked content set in the setting boxes; setting first contents available to the player in the setting boxes from which the first contents have been removed to organize the deck; and during a quest of a game, invoking the deck in response to a player operation and causing the player to use the first contents set in the deck.

### BACKGROUND

### Technical Field

The present invention relates to a recording medium storing instructions and an information processing device.

### Description of Related Art

Conventional video games include games in which a player organizes a deck by setting characters (or cards, etc.) possessed by the player in a plurality of setting boxes, and attempting to clear a quest using this organized deck. Here, the “deck” means a preselected set of characters or cards that can be used in a game.

In this regard, Patent Literature 1 discloses an invention in which, when there is an empty setting box in the deck, a character suited to the quest is automatically set in that setting box.

### PATENT LITERATURE

Patent Literature 1: Japanese Patent No. 6704383

### Technological Problem to be Solved by the Invention

However, with the technique disclosed in Patent Literature 1, when the player performs an operation to remove or replace a character set in a setting box of the deck, characters that the player wants to continue using also end up being removed or replaced, and this creates extra work each time a deck is organized.

### SUMMARY

One or more embodiments of the present invention provide a recording medium storing instructions and an information processing device that have functions to reduce the time and effort it takes for a player to organize a deck.

The recording medium according to a first aspect of the present invention is a non-transitory computer readable recording medium storing instructions for organizing a deck comprising setting boxes in which first contents available to a player are respectively set, the instructions causing an information processing device to execute: in response to a player operation, setting, as a locked content, at least one of the first contents in the setting boxes; removing, from the setting boxes, any first contents other than the locked content set in the setting boxes; setting first contents available to the player in the setting boxes from which the first contents have been removed to organize the deck; and during a quest of a game, invoking the deck in response to a player operation and causing the player to use the first contents set in the deck.

Also, the recording medium according to a second aspect of the present invention is a non-transitory computer readable recording medium storing instructions for organizing a deck comprising setting boxes in which first contents available to a player are respectively set, the instructions causing an information processing device to execute: in response to a player operation, setting, as a locked content, at least one of the first contents in the setting boxes; replacing any first contents other than the locked content with first contents available to the player in the setting boxes to organize the deck; and during a quest of a game, invoking the deck in response to a player operation and causing the player to use the first contents set in the deck.

In a third aspect of the present invention, the instructions cause the information processing device to further execute: determining the first contents to be set in the setting boxes depending on a quest.

Also, in a fourth aspect of the present invention, the instructions cause the information processing device to further execute: in response to a player operation, determining a priority content from among the first contents available to the player, and preferentially selecting the priority content as a first content to be set in one of the setting boxes.

Also, in a fifth aspect of the present invention, the instructions cause the information processing device to further execute: causing a display of a terminal device to display a list of completed decks each including at least one of the setting boxes in which the locked content has been set such that the setting boxes in which the locked contents have been set are displayed differently from the remaining setting boxes; and setting, as a current deck: upon detecting only one completed deck, the completed deck, and upon detecting completed decks, a completed deck selected from the list in response to a player operation.

Also, in a sixth aspect of the present invention, the instructions cause the information processing device to further execute: in response to a player operation, linking a second content to the locked content and to the first contents set in the setting boxes, and locking, as the locked content, the second content linked to the locked content.

Also, in a seventh aspect of the present invention, the instructions cause the information processing device to further execute: determining compatibility between the locked content and the second content, and determining whether to lock the second content to the locked content based on the compatibility.

Also, according to an eighth aspect of the present invention, the information processing device that organizes a deck comprising setting boxes in which first contents available to a player are respectively set, comprising: a hardware processor that: in response to a player operation, sets, as a locked content, at least one of the first contents in the setting boxes; removes, from the setting boxes, any first contents other than the locked content set in the setting boxes; setting first contents available to the player in the setting boxes from which the first contents have been removed to organize the deck; and during a quest of a game, invokes the deck in response to a player operation and causes the player to use the first contents set in the deck.

Also, according to a ninth aspect of the present invention, the information processing device that organizes a deck comprising setting boxes in which first contents available to a player are respectively set, comprising: a hardware processor that: in response to a player operation, sets, as a locked content, at least one of the first contents in the setting boxes; replacing any first contents other than the locked content with first contents available to the player in the setting boxes to organize the deck; and during a quest of a game, invokes the deck in response to a player operation and causes the player to use the first contents set in the deck.

With one or more embodiments of the present invention, it becomes possible to reduce the time and effort it takes for a player to organize a deck.

### BRIEF DESCRIPTION OF THE DRAWINGS

FIG. 1 is a block diagram showing an example of the overall configuration of a game system according to a first embodiment of the present invention;

FIG. 2 is a block diagram schematically showing an example of the hardware configuration of a server device according to the first embodiment of the present invention;

FIG. 3 is a block diagram showing an example of the hardware configuration of a smartphone serving as the terminal device according to the first embodiment of the present invention;

FIG. 4 is a block diagram schematically showing an example of the functional units of a server device according to the first embodiment of the present invention;

FIG. 5 is a block diagram showing a portion of the player information according to the first embodiment of the present invention;

FIG. 6 is a flowchart illustrating an example of the flow of processing when switching from the menu screen to the deck organization screen to organize a deck in the first embodiment of the present invention;

FIG. 7 is a flowchart illustrating an example of the flow of processing for organizing a deck before starting a quest in the first embodiment of the present invention.

FIG. 8 is a schematic diagram showing an example of a deck organization screen according to the first embodiment of the present invention;

FIG. 9 is a schematic diagram showing an example of a priority content selection screen according to the first embodiment of the present invention;

FIG. 10 is a schematic diagram showing an example of a second content setting screen according to the first embodiment of the present invention;

FIG. 11 is a schematic diagram illustrating an example of a completed deck list screen according to the first embodiment of the present invention;

FIG. 12 is a flowchart illustrating an example of the flow of processing when a deck is organized by switching from the menu screen to the deck organization screen in a second embodiment of the present invention;

FIG. 13 is a flowchart illustrating an example of the flow of processing for organizing a deck before starting a quest in the second embodiment of the present invention; and

FIG. 14 is a schematic diagram showing a first content setting tendency confirmation screen according to a modification example of the present invention.

### DETAILED DESCRIPTION

A number of embodiments of the present invention will now be described with reference to the appended drawings. To facilitate understanding of the description, components that are the same will be numbered the same as much as possible in the drawings, and redundant description will be omitted.

### First Embodiment

A first embodiment will be described now.

### Overall Configuration

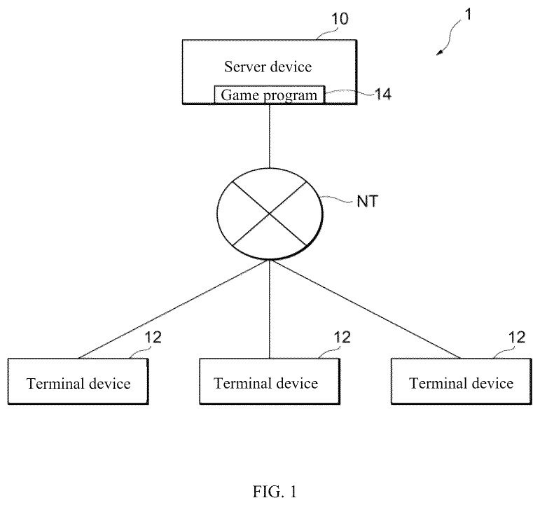

FIG. 1 is a block diagram showing an example of the overall configuration of a game system 1 according to this embodiment.

As shown in FIG. 1, a game system 1 comprises a server device 10 and one or more terminal devices 12. The server device 10 and terminal devices 12 are connected so as to be able to communicate via a communication network NT such as an intranet, the Internet, or a telephone line.

The server device 10 is an information processing device that provides the execution results of a game that can be obtained by executing instructions including a game program 14, or the instructions themselves, to the player of each terminal device 12 via the communication network NT.

Each terminal device 12 is an information processing device belonging to a player, and is an information processing device that provides a game to each player by receiving the execution results of the instructions, or by executing the instructions received from the server device 10 after the instructions have been installed. Examples of these terminal devices 12 include mobile phones and smartphones, tablets, personal computers, video game machines, arcade game machines, and various other such devices.

### Hardware Configuration

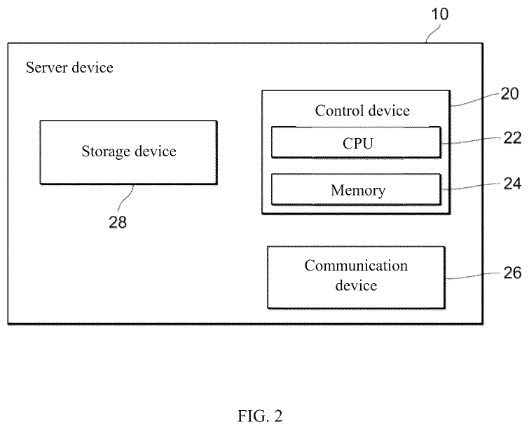

FIG. 2 is a block diagram schematically showing an example of the hardware configuration of the server device 10.

As shown in FIG. 2, the server device 10 comprises a control device (hardware processor) 20, a communication device 26, and a storage device 28. The control device 20 mainly comprises a CPU (central processing unit) 22 and a memory 24 (the primary storage device).

In the control device 20, the CPU 22 functions as various functional units by executing specific instructions stored in the memory 24, the storage device 28, or the like. These functional units will be described in detail below.

The communication device 26 is constituted by a communication interface or the like for communicating with an external device. The communication device 26 sends and receives various kinds of information to and from the terminal device 12, for example.

The storage device 28 is an auxiliary storage device constituted by a hard disk or the like. This storage device 28 stores various kinds of instructions and various kinds of information necessary for the execution of processing in the control device 20, including the game program 14, as well as information about processing results.

The server device 10 can be realized by using an information processing device such as a dedicated or general-purpose server computer. Also, the server device 10 may be constituted by a single information processing device or a plurality of information processing devices distributed on the communication network NT. Also, FIG. 2 shows only a part of the main hardware configuration of the server device 10, and the server device 10 can comprise other components that are ordinarily provided to a server. Also, the hardware configuration of the plurality of terminal devices 12 may have the same configuration as the server device 10, except for further comprising an operating device, a display device, and a sound output device, for example.

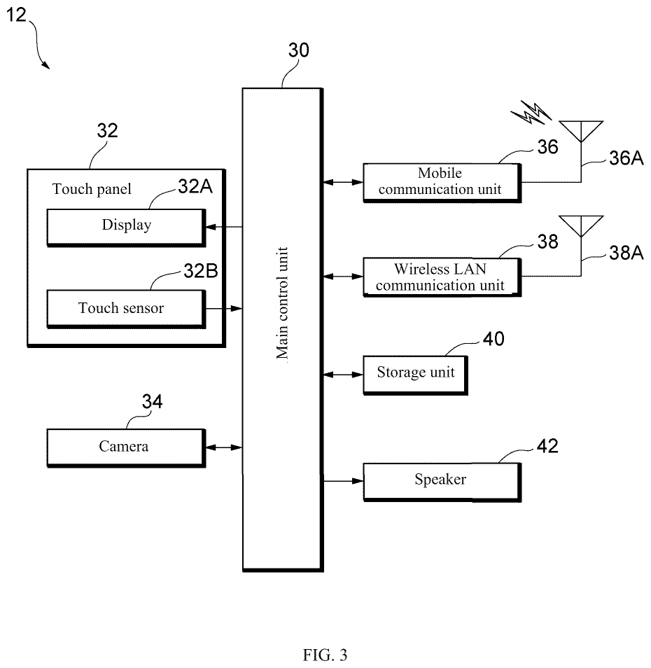

FIG. 3 is a block diagram showing an example of the hardware configuration of a smartphone serving as the terminal device 12 shown in FIG. 1.

As shown in FIG. 3, the terminal device 12 is comprised by a main control unit (i.e., hardware processor) 30, a touch panel (touch screen) 32, a camera 34, a mobile communication unit (or mobile communication interface) 36, a wireless LAN communication unit 38 (or wireless LAN communication interface), a storage unit 40 (or storage), and a speaker 42.

The main control unit 30 includes a CPU, a memory, and so forth. This main control unit 30 is connected to the touch panel 32 (used as a display input device), the camera 34, the mobile communication unit 36, the wireless LAN communication unit 38, the storage unit 40, and the speaker 42. The main control unit 30 has the function of controlling these connected devices.

The touch panel 32 has both a display function and an input function, and is constituted by a display 32A that handles the display function, and a touch sensor 32B that handles the input function. In the first embodiment, the display 32A can display game images including button images, a cross key image, a joystick image, and other such operation input images. The touch sensor 32B can sense the input position of the player with respect to a game image.

The camera 34 has the function of capturing still and moving images, and storing these images in the storage unit 40. The speaker 42 has the function of outputting game sounds and so forth.

The mobile communication unit 36 is connected to a mobile communication network via an antenna 36A, and has the function of communicating (such as via Bluetooth®) with other communication devices that are connected to this mobile communication network.

The wireless LAN communication unit 38 is connected to the communication network NT via an antenna 38A, and has the function of communicating with other devices, such as the server device 10, that are connected to the communication network NT.

The storage unit 40 stores various kinds of instructions and data, such as the game program 14, and play data indicating player information or the progress of the game in the game program 14. This play data may be stored in the server device 10.

### Game Overview

The game according to this embodiment includes a quest, which is a game type that allows a player to acquire content or to give experience points to content that the player already possesses, thereby strengthening or evolving that content.

The above content refers to characters, cards, or the like. For the sake of convenience, this content will hereinafter be referred to as “first content.”

The above quest is a type of game in which the player aims to clear the quest using a deck that was organized according to operations by the player, and is also called a battle game, a dungeon game, a search, a mission, or the like. This deck is organized by setting first content possessed by the player in a plurality of setting boxes.

Furthermore, these quests are executed based on the consumption of a current stamina value associated with the player. When the player clears the quest, that is, when the hit points of an enemy character that appears at the end fall to zero or less, the player can acquire a clearance reward. Examples of clearance rewards include experience points, enemy characters that appeared in the quest, non-charged items, coins, and so forth.

The instructions according to this embodiment allow a player to organize a deck by setting first content possessed by the player in a plurality of setting boxes, and to use this organized deck to proceed through the game.

### Functional Units

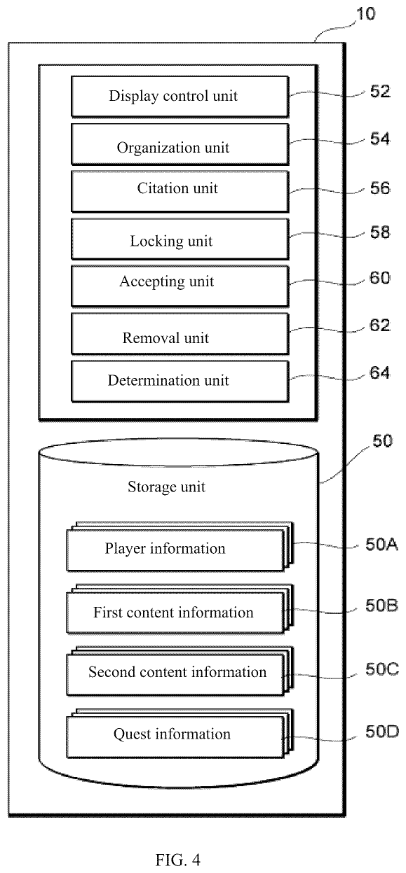

FIG. 4 is a block diagram schematically showing an example of the functional units of the server device 10.

As shown in FIG. 4, the server device 10 comprises, as functional components, a storage unit (or storage) 50, a display control unit 52, an organization unit 54, a citation unit 56, a locking unit 58, an receiving unit 60, a removal unit 62, and a determination unit 64. These functional components are realized when the control device 20 executes instructions such as the game program 14. In addition, some or all of these functional components may be provided to the terminal device 12.

The storage unit 50 has the function of storing player information 50A, first content information 50B, second content information 50C, quest information 50D, and so forth.

Player information 50A is information that is stored in association with the ID for each player. This player information 50A includes the player's name, age, player rank information, stamina information, and so forth (not depicted in the drawings).

Player rank information may include a value that increases when the player acquires experience points, for example.

Stamina information includes the player's current stamina value and stamina upper limit value. The current stamina value is the value consumed when the player executes various quests. This current stamina value increases by a specific amount (such as 1) after a certain period of time (such as 3 minutes) elapses, and recovers to the stamina upper limit value. Also, this current stamina value is recovered beyond the stamina upper limit value when the player consumes paid currency, unpaid currency, stamina recovery items, and so forth. This stamina upper limit value increases along with increases in the player rank. Paid currency is paid content that can be acquired through a purchase procedure (payment) using money, a prepaid card, a credit card, electronic money, crypto assets, and so on. Examples of paid currency include charged items (paid items), charged coins (paid coins), charged points (paid points), and so on. For instance, in the game according to the first embodiment, one charged item can be purchased for 100 yen. Meanwhile, unpaid currency is unpaid content that can be acquired by executing the game. Examples of unpaid currency include non-charged items (unpaid items), non-charged coins (unpaid coins), and non-charged points (unpaid points). Examples of executing a game may include the player logging into the game, winning in a quest, and completing a mission. Unpaid currency can be consumed in the same way as paid currency in various kinds of games.

First content information 50B is information that is stored in association with the ID for each first content. First content information 50B includes the name, image, ability parameter information, and rarity of the first content (for example, a character).

Ability parameter information includes the initial values and maximum values for the various ability parameters (for instance, hit points, attack power, defense power, special parameters, etc.).

Rarity may be represented by a number within a specified range, such as from 1 to 6, for example. This number may be indicated by a number of stars, for example. Here, a character with a high rarity is set with an ability parameter or the like that is advantageous in a quest.

Second content information 50C is information that is stored in association with the ID for each second content. “Second content” refers to content that is different from the first content. For example, if the first content is a character, the second content may be the character's equipment, such as weapons, armor, or accessories. Second content information 50C includes the name, image, and performance parameter information of the second content (for example, equipment).

Quest information 50D is information that is stored in association with the ID for each quest. Quest information 50D includes the quest name, consumed stamina value, enemy character information, clearance reward information, and so forth (not depicted in the drawings).

Consumed stamina value includes the value required to execute the quest. This consumed stamina value is consumed from the player's current stamina value, and the higher the difficulty of the quest, the higher the consumed stamina value may be, for example.

Enemy character information includes the IDs and ability parameters of the enemy characters that appear in the quest.

Clearance reward information includes the number of experience points, unpaid items (such as free stones) and coins that can be acquired when the quest is cleared, the IDs and drop rates of enemy characters (that can be acquired), and so forth. The drop rate is the probability that the player will earn an enemy character.

The first content information 50B, the second content information 50C, and the quest information 50D are updated from time to time via a game update by the game operator.

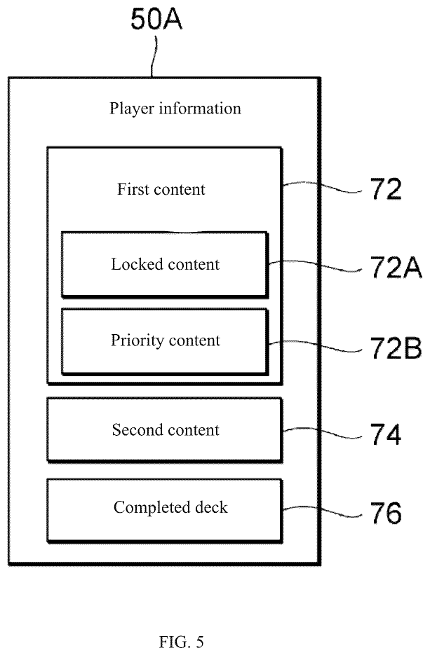

FIG. 5 is a block diagram showing a portion of the player information 50A. As shown in FIG. 5, the player information 50A includes first content 72, second content 74, and a completed deck 76, in addition to the player rank information discussed above.

The first content 72 is first content possessed by the player, and includes an ID, a name, an image, and ability parameters. This first content 72 can be set in a setting box of the deck according to operations by the player.

The first content 72 includes locked content 72A and priority content 72B. As will be described in detail below, the locked content 72A is determined by the locking unit 58 based on operations by the player, and the priority content 72B is determined by the organization unit 54 based on operations by the player.

The second content 74 is second content possessed by the player, and includes an ID, a name, an image, and ability parameters. The second content 74 can be linked to the first content 72 set in the setting boxes of the deck according to operations by the player.

A completed deck 76 is a deck that has already been organized according to operations by the player. For the sake of convenience, this already-organized deck will be referred to hereinafter as a “completed deck.”

Returning to FIG. 4, the display control unit 52 is a functional unit for controlling the display of various screens. Also, in particular, the display control unit 52 controls the display of a list of completed decks 76 when there are a plurality of decks in which the first content 72 has been locked or set in the setting boxes of the deck by the locking unit 58 and the organization unit 54 (i.e., a completed deck 76).

The organization unit 54 organizes a deck by setting first content 72 possessed by the player in the setting boxes of the deck from which first content 72 has been removed by the removal unit 62. Also, the organization unit 54 may determine the first content 72 to be set in the setting boxes of the deck from which first content 72 has been removed by the removal unit 62, depending on the quest.

Furthermore, the organization unit 54 may determine the priority content 72B in advance from among the first content 72 based on operations by the player. In this case, the organization unit 54 determines the first content 72 to be set in the setting boxes of the deck from which first content has been removed by the removal unit 62 by preferentially selecting from among the priority content 72B.

Furthermore, the organization unit 54 may determine the priority content 72B in advance from among the first content 72 based on operations by the player, and may preferentially select, from among the priority content 72B, the first content 72 to be set in the setting boxes of the deck from which first content has been removed by the removal unit 62, and determine the first content 72 depending on the quest.

When there is only one completed deck 76, the citation unit 56 sets this completed deck 76 as the current deck, and when there are a plurality of completed decks 76, the citation unit 56 sets a completed deck 76 selected from the list as the current deck according to operations by the player.

Also, the organization unit 54 can link the second content 74 to the locked content 72A and the first content 72 set in the setting boxes based on operations by the player.

The locking unit 58 sets some of the first content 72 set in the setting boxes of the deck as locked content 72A based on operations by the player on the deck organization screen displayed by the display control unit 52.

The receiving unit 60 is a functional unit for receiving operations (requests) from the player. A description of how the player's operations are received by the receiving unit 60 is not included herein.

The removal unit 62 removes from the setting boxes any first content 72 other than the locked content 72A from among the first content 72 set in the setting boxes of the deck.

The determination unit 64 determines the compatibility between the locked content 72A and the second content 74 linked to this locked content 72A by the organization unit 54.

Also, when second content 74 is linked to locked content 72A, the locking unit 58 determines whether to lock the second content 74 to the locked content 72A based on the compatibility determined by the determination unit 64, and if the decision is affirmative, locks the second content 74 to the locked content 72A.

Execution Processing When Switching from Menu Screen to Deck Organization Screen

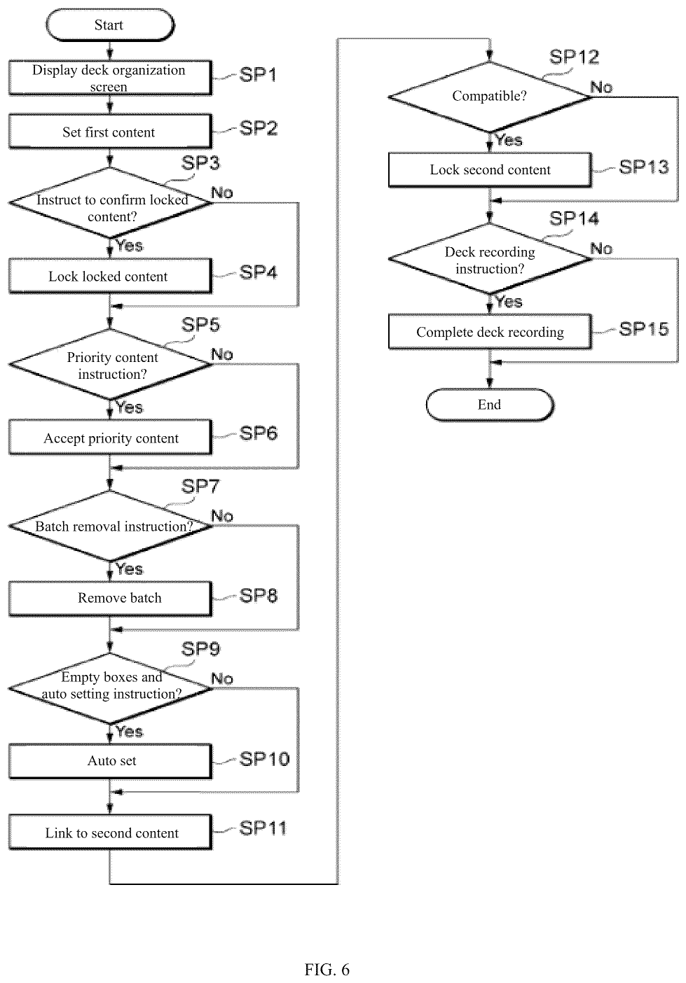

FIG. 6 is a flowchart illustrating an example of the flow of processing when switching from the menu screen to the deck organization screen to organize a deck. Note that the following steps are merely examples, and the order and details may be changed as needed.

### (Step SP1)

The display control unit 52 performs control to switch the screen display (of the touch panel 32, etc.) from the menu screen to the deck organization screen based on operations by the player. The processing then proceeds to step SP2.

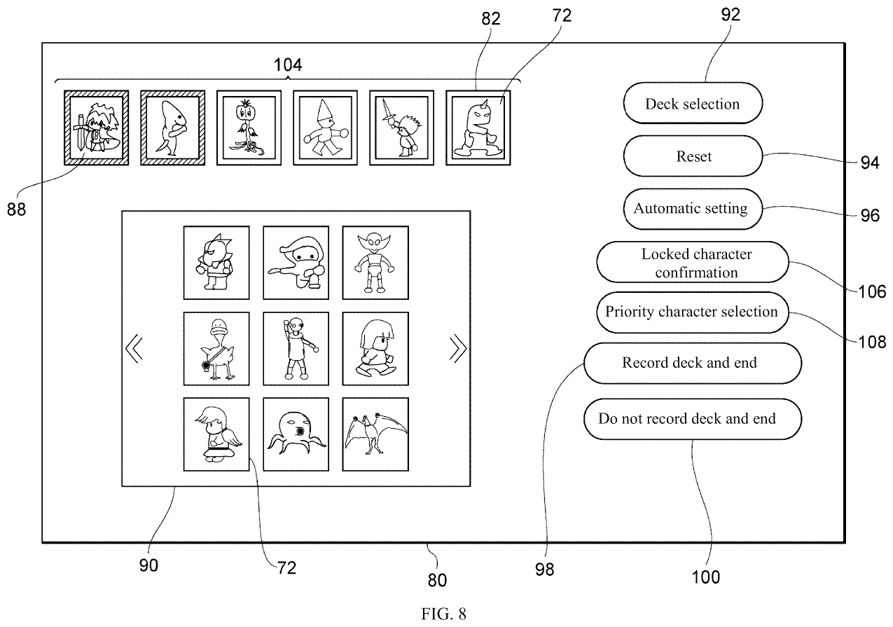

FIG. 8 is a schematic diagram showing an example of the deck organization screen 80.

As shown in FIG. 8, the deck organization screen 80 is provided with a setting box 82, a first content list 90, a deck selection button 92, a reset button 94, an automatic setting button 96, end buttons 98 and 100, a deck 104, a locked character confirmation button 106, and a priority character selection button 108.

Of these, the deck 104 has a plurality of setting boxes 82 arranged in the initial state. After this, the display (color, etc.) of some of the setting boxes 82 may be changed through operations by the player (discussed below). This shall be referred to as “setting” a setting box 82. Also, an image of the first content 72 is displayed in the first content list 90. The functions of the other buttons will be described below.

### (Step SP2)

The organization unit 54 receives, according to operations by the player, the designation of a first content 72 displayed in the first content list 90 on the deck organization screen 80, and sets this in the setting box 82 (FIG. 8 shows a state in which the first content 72 has been set in the setting box 82). One or more setting boxes 82 are provided in the deck 104, and a first content 72 is set for each respective setting box 82. This setting may be performed for all of the setting boxes 82, or just for some of them (these operations may be performed on the touch panel 32, etc., for example; the same applies in the following steps). The processing then proceeds to step SP3.

### (Step SP3)

The step to which the processing proceeds branches depending on whether the player has performed an operation to confirm the locked content 72A. If an operation to confirm has been performed, the processing proceeds to step SP4; if not, the processing proceeds to step SP5.

Here, an operation by the player to confirm the locked content 72A may refer to, for example, an operation in which the player presses (clicks or taps) the first content 72 set in the setting box 82 on the deck organization screen 80 shown in FIG. 8, that is, the player designates the first content 72 to be locked, after which he or she presses (clicks or taps) the locked character confirmation button 106.

### (Step SP4)

In step SP3, when the player performs an operation to confirm the locked content 72A, the locking unit 58 sets the first content 72 designated by this operation as locked content 72A and locks the first content 72 in the setting box 82 in which it was set and the display control unit 52 changes the display (color, etc.) of that setting box 82. The deck 104 in FIG. 8 shows a state in which the color of two out of six setting boxes 82 has been changed. The processing then proceeds to step SP5.

An example of the processing for locking to a setting box 82 will now be described. For example, the first content 72 set in the setting box 82 may be in a state in which a flag is lowered (initial state), and the processing to lock the first content 72 in the setting box 82 may refer to raising this flag. This makes it possible to distinguish between a state of being set in a setting box 82 and a state of being locked.

### (Step SP5)

The step to which the processing proceeds branches depending on whether the player has performed an operation to confirm the priority content 72B. If an operation to confirm has been performed, the processing proceeds to step SP6; if not, the processing proceeds to step SP7.

In an example of an operation by the player to confirm the priority content 72B, in FIG. 8, the player first presses (clicks or taps) the priority character selection button 108, which causes the display control unit 52 to control the display of a priority content selection screen. Then, on that screen, the player performs an operation to select the priority content 72B.

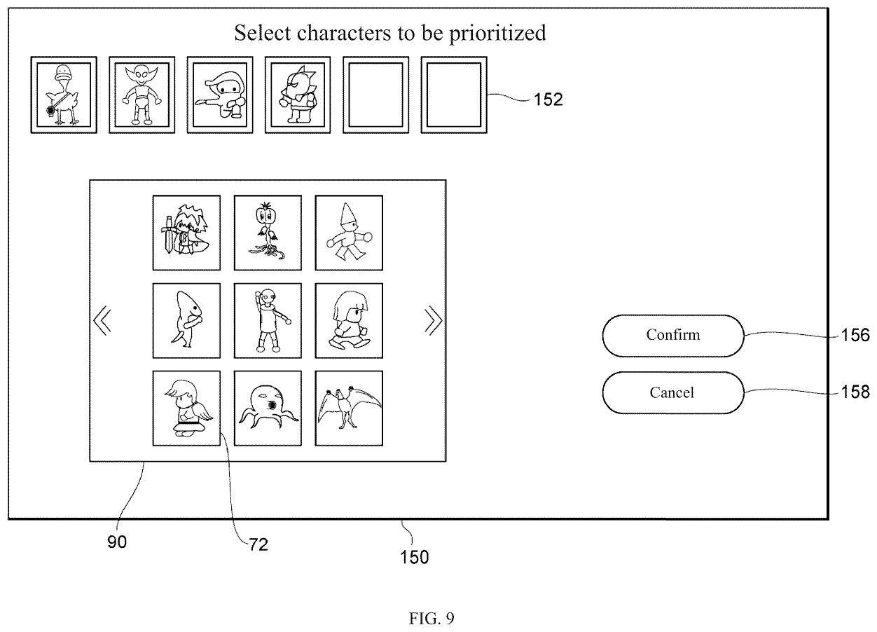

FIG. 9 is a schematic diagram showing an example of the priority content selection screen 150. As shown in FIG. 9, the priority content selection screen 150 is provided with a first content list 90, first content 72, a priority content box 152, a confirmation button 156, and a cancel button 158. Of these, the first content list 90 was described with reference to FIG. 8 and therefore will not be described again.

The player designates a first content 72 from the first content list 90, moves this to a priority content box 152 (by sliding it, for example), and presses (clicks or taps) the confirmation button 156, whereupon the organization unit 54 confirms the first content 72 in the priority content box 152 as priority content 72B.

Several priority content boxes 152 may be provided and several items of priority content 72B may be confirmed. However, the number of priority content boxes 152 and the number of items of priority content 72B do not necessarily have to be the same. That is, the number of items of priority content 72B may be equal to or less than the number of priority content boxes 152. For instance, in FIG. 9, there are six priority content boxes 152 but only four items of priority content 72B.

If the priority character selection button 108 is not pressed on the deck organization screen 80, and if the cancel button 158 is pressed on the priority content selection screen 150, it is assumed that the player has not performed any operation to confirm the priority content 72B, and the processing proceeds directly to step SP7.

### (Step SP6)

In step SP5, when the player performs an operation to confirm the priority content 72B, this is received (by the receiving unit 60 in FIG. 4) and stored in the storage unit 50. The processing then proceeds to step SP7.

### (Step SP7)

The step to which the processing proceeds branches depending on whether the player has performed an operation to instruct a batch removal. If an operation to instruct has been performed, the processing proceeds to step SP8; if not, the processing proceeds to step SP9.

Here, an operation by the player to instruct a batch removal may refer to, for example, an operation of pressing (clicking or tapping) the reset button 94 on the deck organization screen 80 shown in FIG. 8.

### (Step SP8)

In step SP7, if the player performs an operation to instruct a batch removal, the removal unit 62 performs a batch removal of the first content 72 set in the setting boxes 82 based on this operation by the player. The setting boxes 82 from which the first content 72 has been removed are now empty. The locked content 72A, however, is not removed. The processing then proceeds to step SP9.

### (Step SP9)

The step to which the processing proceeds branches depending on whether there are any empty setting boxes 82 and if the player has performed an operation to instruct automatic setting. If there are any empty setting boxes 82 and the player has performed an operation to instruct automatic setting, the processing proceeds to step SP10; otherwise, the processing proceeds to step SP11.

Here, an operation by the player to instruct automatic setting may refer to, for example, an operation of pressing (clicking or tapping) the automatic setting button 96 on the deck organization screen 80 shown in FIG. 8.

### Step SP10

In step SP9, if there are any empty setting boxes 82 and the player has performed an operation to instruct automatic setting, the organization unit 54 sets (automatically sets) the first content 72 in the empty setting boxes 82. However, in this setting operation, the priority content 72B stored in step SP6 is selected and set preferentially. The processing then proceeds to step SP11.

If step SP10 is not performed, and if there are any empty setting boxes 82 in the deck 104, the first content 72 will be set in the empty setting boxes 82 according to operations by the player on the deck organization screen 80 shown in FIG. 8.

### (Step SP11)

Based on operations by the player, the organization unit 54 links the second content 74 to the locked content 72A locked in the setting boxes 82 and the first content 72 set in the setting boxes 82. The processing then proceeds to step SP12.

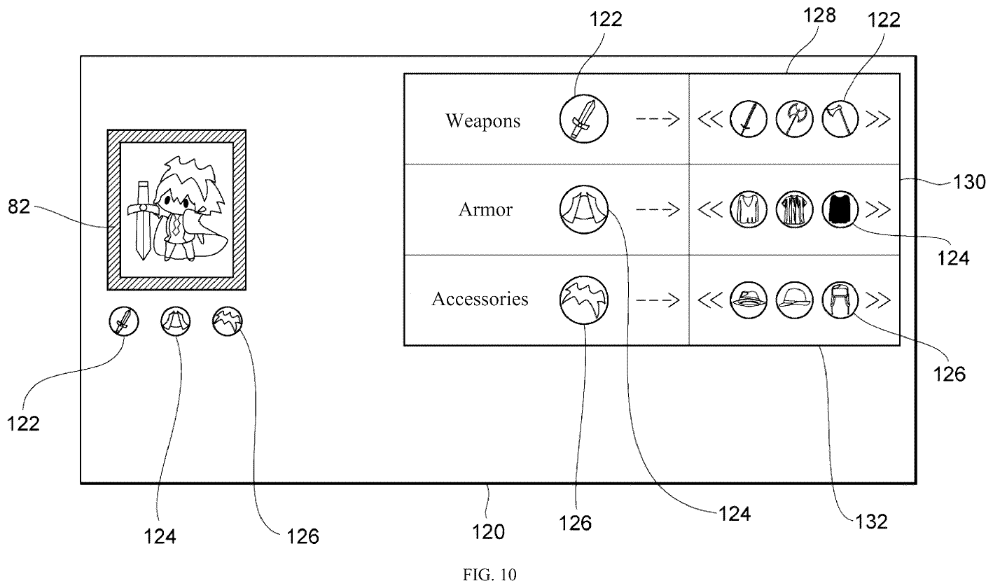

FIG. 10 is a schematic diagram showing an example of a second content setting screen 120 for linking the second content 74. The second content setting screen 120 shown in FIG. 10 is a screen for linking the second content 74 to the locked content 72A, but of course the second content 74 can also be linked to the first content 72 set in the setting boxes 82.

As shown in FIG. 10, the second content setting screen 120 is provided with second content lists 128, 130, and 132, and displays an image of the locked content 72A (or the set first content 72) and an image of the second content 74 linked to the locked content 72A.

Also, in the example shown in FIG. 10, the second content 74 is divided into three types: second content 122, 124, and 126. Of these, the second content 122 is represented by weapons, the second content 124 is represented by armor, and the second content 126 is represented by accessories.

For example, the player may select an image of one of the second content 122 items from the second content list 128 and links this to the locked content 72A. Similarly, operations may be performed in which an image of one of the second content 124 items is selected from the second content list 130 and linked to the locked content 72A, and an image of one of the second content 126 items is selected from the second content list 132 and linked to the locked content 72A.

### (Step SP12)

The determination unit 64 determines whether the locked content 72A and the second content 74 (122, 124, 126) linked to the locked content 72A are compatible with each other. The determination unit 64 determines this compatibility by taking into account the type of locked content 72A (such as a hero, soldier, wizard, or other such type) and the type of second content 74 (such as a sword, spear, gun, or other such type in the case of second content 122). Alternatively, for example, parameters such as compatibility and attributes may be set in advance for each first content 72 and each second content 74, and a determination may be made based on the relationship thereof. If it is determined that the compatibility is good, the processing proceeds to step SP13; if it is determined that the compatibility is bad, the processing proceeds to step SP14.

### (Step SP13)

If it is determined in step SP12 that the compatibility is good, the locking unit 58 locks the second content 74 to the locked content 72A. This locking may be performed via a process such as putting up a flag, as explained in step SP4. The processing then proceeds to step SP14.

In the flowchart in FIG. 6, the organization of the deck 104 is completed by the processing up to steps SP12 and SP13. As already described, the deck 104 thus organized is referred to as a completed deck 76.

### (Step SP14)

The step to which the processing proceeds branches depending on whether the player has performed an operation to instruct recording of the completed deck 76. If an operation to instruct has been performed, the processing proceeds to step SP15; if not, the processing in the flowchart in FIG. 6 comes to an end.

Here, an operation by the player to instruct recording of the completed deck 76 may refer to, for example, an operation of pressing (clicking or tapping) the “record deck” end button 98 from among the end buttons 98 and 100 in FIG. 8.

Conversely, an operation that does not instruct recording of the completed deck 76 may refer to, for example, an operation of pressing (clicking or tapping) the “do not record deck” end button 100 from among the end buttons 98 and 100 in FIG. 8.

### (Step SP15)

In step SP14, when an operation to instruct recording of the completed deck 76 is performed, the storage unit 50 stores information about the completed deck 76 (locked content 72A, first content 72, and second content 74). Then, the processing shown in the flowchart in FIG. 6 ends.

In steps SP3 and SP4 in the flowchart in FIG. 6, it was described that some of the deck 104 is set as locked content 72A, but the entire deck 104 may be locked content 72A, forming a locked deck.

In addition, in steps SP7 and SP8, it was described that a plurality of first content 72 items set in the setting boxes 82 are removed as a batch, but only some of the first content 72 items designated according to operations by the player may be removed instead.

### Execution Processing Before Start of Quest

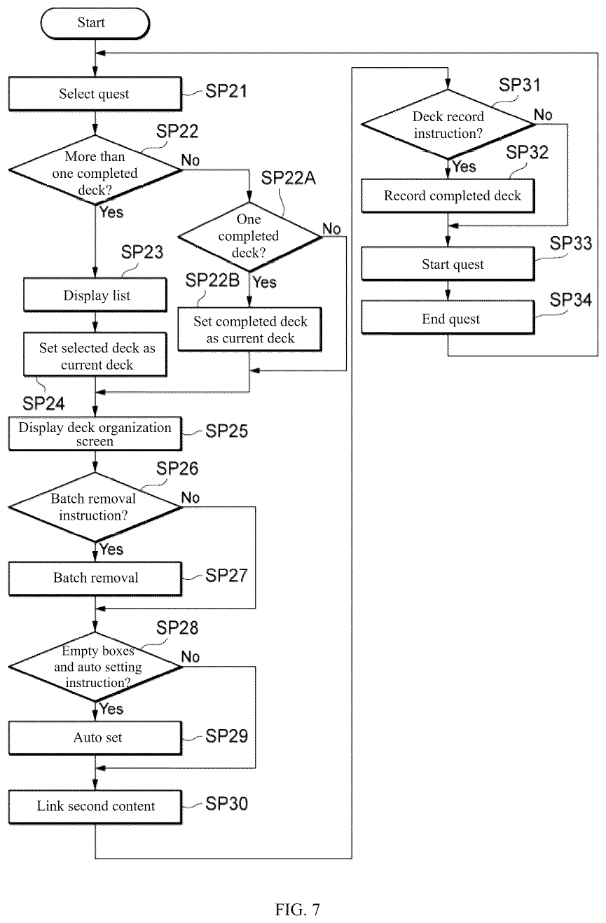

FIG. 7 is a flowchart illustrating an example of the flow of processing for organizing a deck before starting a quest. However, the processing illustrated in FIG. 7 starts after the processing illustrated in FIG. 6 has already been completed. Note that the following steps are merely an example, and the order and details may be changed as needed.

### (Step SP21)

A game quest is selected according to operations by the player (not depicted in the drawings). The processing then proceeds to step SP22.

### (Step SP22)

The step to which the processing proceeds branches depending on whether there are a plurality of completed decks 76 stored in the storage unit 50. If there are more than one, the processing proceeds to step SP23; if not, the processing proceeds to step SP22A.

### (Step SP23)

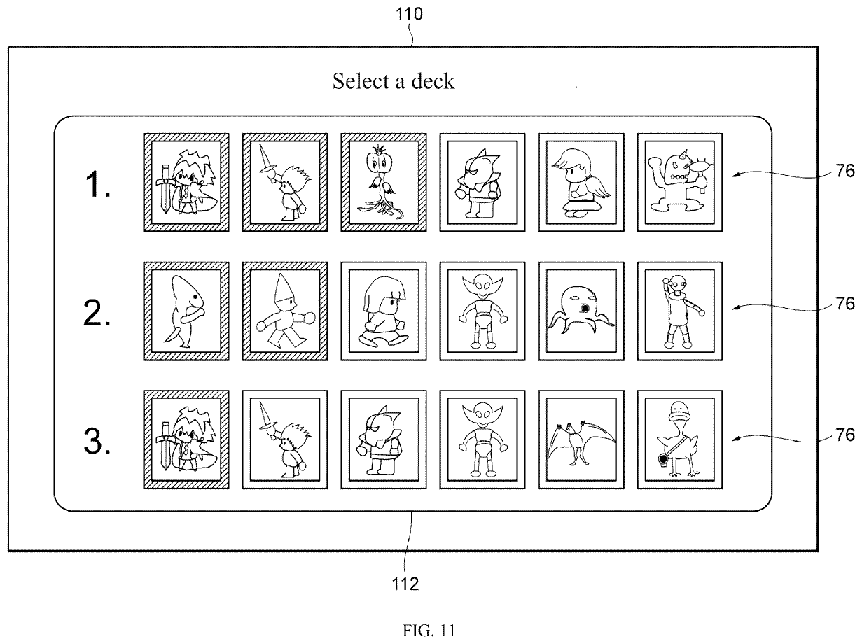

If there are a plurality of completed decks 76, the display control unit 52 controls the display of the completed deck list screen. FIG. 11 is a schematic diagram illustrating an example of the completed deck list screen 110. As shown in FIG. 11, the completed deck list screen 110 is provided with a completed deck list 112 having a plurality of completed decks 76. The processing then proceeds to step SP24.

### (Step SP24)

A completed deck 76 is selected from the completed deck list 112 according to operations by the player. The citation unit 56 sets the completed deck 76 selected according to these operations by the player as the current deck 104. The processing then proceeds to step SP25.

### (Step SP22A)

If there are not a plurality of completed decks 76, the step to which the processing proceeds branches depending on whether there is one completed deck 76. If there is one, the processing proceeds to step SP22B; if not, that is, if the number is zero, the processing proceeds to step SP25.

### (Step SP22B)

If there is one completed deck 76, the citation unit 56 sets the completed deck 76 as the current deck 104. The processing then proceeds to step SP25.

### (Step SP25)

The display control unit 52 performs control to switch the display on the touch panel 32 to the deck organization screen 80. However, if the current deck 104 is set in steps SP24 and SP22B, that deck 104 is displayed on the deck organization screen 80. The processing then proceeds to step SP23.

### (Step SP26)

The step to which the processing proceeds branches depending on whether the player has performed an operation to instruct a batch removal. If an operation to instruct has been performed, the processing proceeds to step SP27; if not, the processing proceeds to step SP28.

Here, an operation by the player to instruct a batch removal may refer to, for example, an operation of pressing (clicking or tapping) the reset button 94 on the deck organization screen 80 shown in FIG. 8.

### (Step SP27)

In step SP27, if the player performs an operation to instruct a batch removal, the removal unit 62 performs a batch removal of the first content 72 set in the setting boxes 82 based on that operation by the player. The setting boxes 82 from which the first content 72 has been removed are now empty. However, the locked content 72A is not removed at this time. The processing then proceeds to step SP28.

### (Step SP28)

The step to which the processing proceeds branches depending on whether there are any empty setting boxes 82 and if the player has performed an operation to instruct automatic setting. If there are any empty setting boxes 82 and the player has performed an operation to instruct automatic setting, the processing proceeds to step SP29; otherwise, the processing proceeds to step SP30.

Here, an operation by the player to instruct automatic setting may refer to, for example, an operation of pressing (clicking or tapping) the automatic setting button 96 on the deck organization screen 80 shown in FIG. 8.

### (Step SP29)

In step SP28, if there are any empty setting boxes 82 and the player has performed an operation to instruct automatic setting, the organization unit 54 sets (automatically sets) the first content 72 in the empty setting boxes 82. However, the organization unit 54 preferentially selects and sets the priority content 72B stored in step SP6 in FIG. 6. The processing then proceeds to step SP30.

### (Step SP30)

The organization unit 54 links each second content 74 to the locked content 72A and to the first content 72 set in the setting boxes 82 based on operations by the player. The processing then proceeds to step SP31.

If there is second content 74 that has been locked in step SP13 in FIG. 6 to the locked content 72A of the current deck 104, that second content 74 remains in a locked state.

Therefore, in step SP30, the organization unit 54 links the second content 74 to the locked content 72A to which second content 74 has not been locked as well as to the set first content 72, based on operations by the player. These operations by the player may be performed on the second content setting screen 120 shown in FIG. 10, for example.

### (Step SP31)

The step to which the processing proceeds branches depending on whether the player has performed an operation to instruct recording of the completed deck 76. If an operation to instruct has been performed, the processing proceeds to step SP32; if not, the processing proceeds to SP33.

Here, an operation by the player to instruct recording of the completed deck 76 may refer to, for example, an operation of pressing (clicking or tapping) the “record deck” end button 98 from among the end buttons 98 and 100 in FIG. 8.

Conversely, an operation that does not instruct recording of the completed deck 76 may refer to, for example, an operation of pressing (clicking or tapping) the “do not record deck” end button 100 from among the end buttons 98 and 100 in FIG. 8.

### (Step SP32)

In step SP31, when an operation to instruct recording of the completed deck 76 is performed, the storage unit 50 stores information about the completed deck 76 (locked content 72A, first content 72, and second content 74). The processing then proceeds to step SP33.

### (Step SP33)

In step SP21, the quest chosen by the player is begun, and the display control unit 52 transitions to a quest screen (not depicted in the drawings). The processing then proceeds to step SP34.

### (Step SP34)

The quest is ended. After the quest has ended, the processing returns to step SP21, and the player selects a new quest. The removal unit 62 may remove everything other than the locked content 72A from the setting boxes 82 at the point when the quest is ended.

### Technological Effect

As discussed above, the first embodiment is a non-transitory computer readable recording medium storing instructions for organizing a deck 104 by setting first content 72 possessed by the player in a plurality of setting boxes 82 and using this deck 104 to proceed through a game, the instructions causing a computer to function based on operations by the player as: the locking unit 58 for setting some of the first content 72 set in the setting boxes 82 as locked content 72A; the removal unit 62 for removing from the setting boxes 82 any first content 72 other than the locked content 72A set in the setting boxes 82; and an organization unit 54 for setting first content 72 possessed by the player in the setting boxes 82 from which first content 72 was removed by the removal unit 62, thereby organizing the deck 104.

With this configuration, it is possible to remove the first content 72 (character cards, etc.) set in the setting boxes 82 other than the locked content 72A (character cards, etc., that the player wants to keep using), and furthermore, it is possible to automatically reset the first content 72 in the setting boxes 82 from which first content 72 has been removed, so the time and effort it takes the player to organize the deck 104 can be reduced.

Also, with the first embodiment, the organization unit 54 determines priority content 72B from among the first content 72 possessed by the player based on operations by the player, and determines the first content 72 to be set by preferentially selecting it from among the priority content 72B.

With this configuration, the player can preferentially set the priority content 72B (such as character cards that the player wants to develop) that the player has designated in advance in the deck 104, and using this deck 104 motivates the player to play the game.

For example, if the locked content 72A is a high-level character card, then the priority content 72B can be a low-level character card that the player wants to develop, making it more likely that the player will be able to clear a difficult quest, so character cards the player wants to develop can efficiently accumulate experience points.

Also, with the first embodiment, the organization unit 54 determines priority content 72B from among the first content 72 possessed by the player based on operations by the player, and determines the first content 72 to be set by preferentially selecting it from among the priority content 72B and depending on the quest (difficulty level, tendencies, gimmicks, enemies that appear, etc.).

With this configuration, the first content 72 to be set is determined by taking quests into account while giving priority to the priority content 72B (such as character cards to be developed) that the player has designated in advance, so a quest can be cleared more easily and the deck 104 can be organized with priority given to the priority content 72B, and this motivates the player to play the game.

Also, in the first embodiment, the computer is made to function based on operations by the player as a display control unit 52 for controlling the display of a list 112 of completed decks 76, which are decks 76 in which the first content 72 has been locked or set in the setting boxes 82 by the locking unit 58 and the organization unit 54, when there are a plurality of completed decks 76, and for displaying the setting boxes 82 in which the locked content 72A has been locked differently from the other setting boxes 82; and the citation unit 56 for setting a completed deck 76 as the current deck 104 when there is only one completed deck 76, and for setting a completed deck 76 selected from the list 112 as the current deck 104 according to operations by the player when there are a plurality of completed decks 76.

With this configuration, a completed deck 76 can be set as the current deck 104, so the time and effort it takes the player to organize the deck 104 can be reduced.

Also, in the first embodiment, the organization unit 54 links a second content 74 that is different from the first content 72 to the locked content 72A and to the first content 72 set in the setting boxes 82 based on operations by the player, and the locking unit 58 locks to the locked content 72A the second content 74 that is linked to the locked content 72A.

With this configuration, unnecessary work can be avoided when organizing the deck 104.

Also, in the first embodiment, a computer is made to function as the determination unit 64 for determining compatibility between the locked content 72A and the second content 74, and the locking unit 58 determines whether to lock the second content 74 to the locked content 72A based on the compatibility determined by the determination unit 64.

With this configuration, second content 74 that is compatible with the locked content 72A can be locked, and second content 74 that is incompatible will not be locked, and this further reduces unnecessary work when organizing the deck 104.

### Second Embodiment

A second embodiment will now be described. This embodiment differs from the first embodiment in that replacement processing is performed instead of the removal and automatic setting performed in the first embodiment. In the following description, overlap with the first embodiment will be omitted as much as possible, focusing on the parts that are different.

### Functional Units

In this embodiment, the removal unit 62 described in the first embodiment is not provided, and the function of the organization unit 54 is different from that in the first embodiment.

That is, the organization unit 54 organizes the deck 104 by setting first content 72 possessed by the player, so as to replace any first content 72 set in the setting boxes 82 of the deck 104 with first content 72 other than the locked content 72A locked by the locking unit 58.

The organization unit 54 may also determine the first content 72 to be set in the setting boxes 82 of the deck 104, depending on the quest.

Furthermore, the organization unit 54 may determine the first content 72 to be set in the setting boxes 82 of the deck 104 by preferentially selecting it from among the priority content 72B.

Furthermore, the organization unit 54 may preferentially select the first content 72 to be set in the setting boxes 82 of the deck 104 from among the priority content 72B, and may determine the first content 72 depending on the quest.

Execution Processing When Switching from Menu Screen to Deck Organization Screen

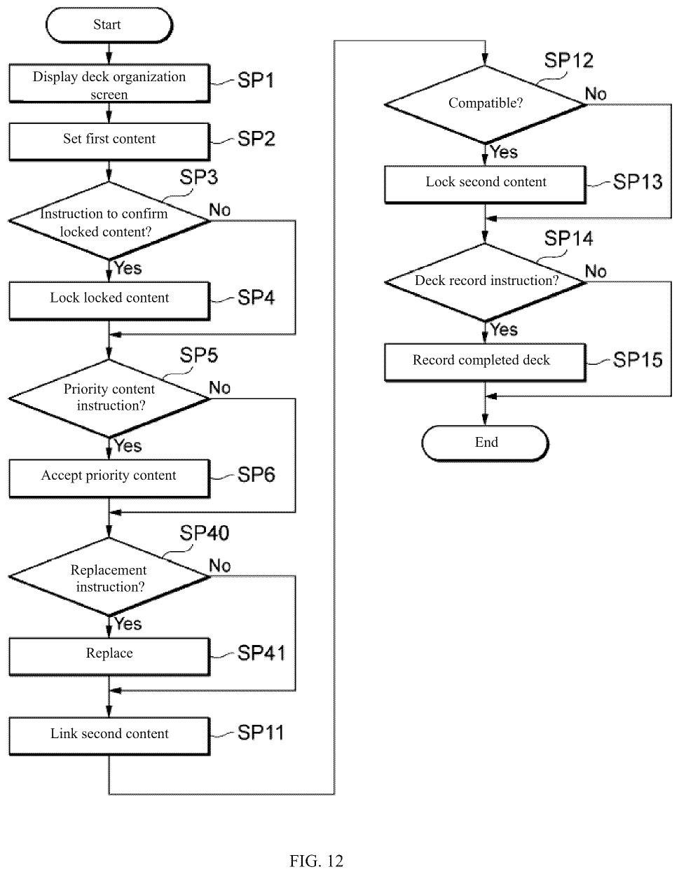

FIG. 12 is a flowchart illustrating an example of the flow of processing when switching from the menu screen to the deck organization screen to organize a deck. Note that the following steps are merely examples, and the order and details may be changed as needed. Also, the steps in FIG. 12 that overlap with FIG. 6 will be omitted.

### (Step SP40)

After steps SP1 to SP6 are completed, the step to which the processing proceeds branches depending on whether the player has performed an operation to instruct replacement. If the player has performed an operation to instruct replacement, the processing proceeds to step SP41; if not, the processing proceeds to step SP11.

Here, an operation by the player to instruct replacement may refer to, for example, an operation of pressing (clicking or tapping) the automatic setting button 96 in FIG. 8.

### (Step SP41)

In step SP40, if the player has performed an operation to instruct replacement, the organization unit 54 replaces the first content 72 set in the deck 104. This replacement may refer to organizing the deck 104 by newly setting first content 72 possessed by the player so as to replace the first content 72 set in the setting boxes 82 in FIG. 8, for example. The processing then proceeds to step SP11.

At this point, if there are any empty setting boxes 82 in the deck 104, the organization unit 54 sets first content 72 in those setting boxes 82 as well.

If step SP40 is not performed, and if there are any empty setting boxes 82 in the deck 104, the first content 72 will be set in the empty setting boxes 82 according to operations by the player on the deck organization screen 80 shown in FIG. 8. The processing then proceeds to step SP12.

### Execution Processing Before Start of Quest

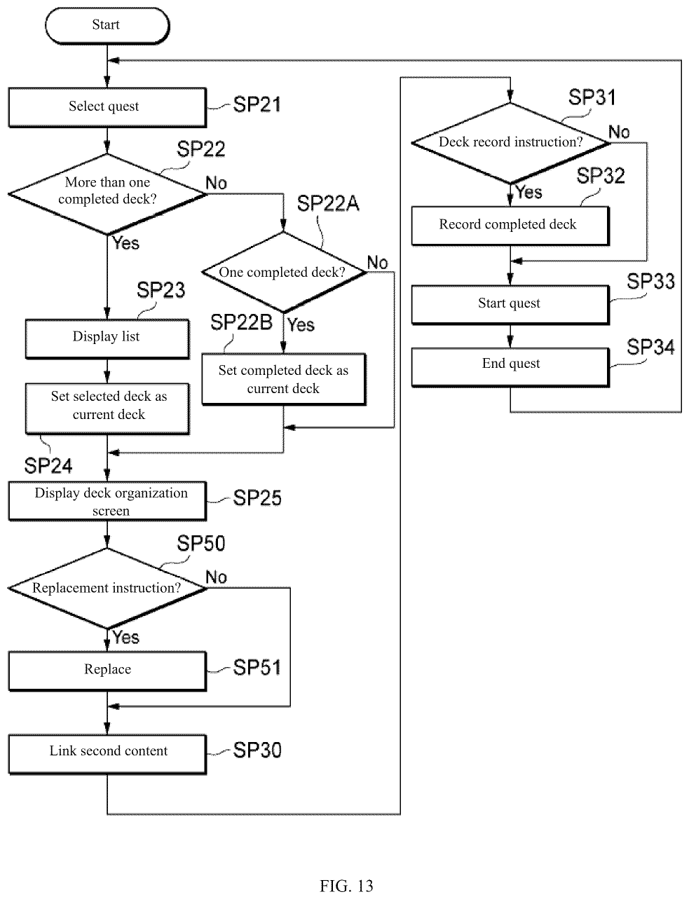

FIG. 13 is a flowchart illustrating an example of the flow of processing for organizing a deck before starting a quest. However, the processing illustrated in FIG. 13 starts after the processing illustrated in FIG. 12 has already been completed.

Note that the following steps are merely examples, and the order and details may be changed as needed. Also, the steps in FIG. 13 that overlap with FIG. 7 will be omitted.

### (Step SP50)

After steps SP21 to SP25 are completed, the step to which the processing proceeds branches depending on whether the player has performed an operation to instruct replacement. If the player has performed an operation to instruct replacement, the processing proceeds to step SP51; if not, the processing proceeds to step SP30.

Here, an operation by the player to instruct replacement may refer to, for example, an operation of pressing (clicking or tapping) the automatic setting button 96 in FIG. 8.

### (Step SP51)

In step SP40, if the player has performed an operation to instruct replacement, the organization unit 54 replaces the first content 72 set in the deck 104. This replacement may refer to organizing the deck 104 by newly setting first content 72 possessed by the player so as to replace the first content 72 set in the setting boxes 82 in FIG. 8, for example. The processing then proceeds to step SP30.

### Technological Effect

As discussed above, the second embodiment is a non-transitory computer readable recording medium storing instructions for organizing a deck 104 by setting first content 72 possessed by the player in a plurality of setting boxes 82 and using this deck 104 to proceed through a game, the instructions causing a computer to function based on operations by the player as: the locking unit 58 for setting some of the first content 72 set in the setting boxes 82 as locked content 72A; and an organization unit 54 for organizing the deck by setting first content 72 possessed by the player in the setting boxes 82 so as to replace any first content 72 other than the locked content 72A from among the first content 72 set in the setting boxes 82.

With this configuration, it is possible to replace the first content 72 (character cards, etc.) set in the setting boxes 82 other than the locked content 72A (character cards, etc., that the player wants to keep using), which saves the player time and effort when organizing the deck 104.

### MODIFICATION EXAMPLES

The present invention is not limited to or by the above embodiments. That is, suitable design changes made to the above specific examples by a person skilled in the art are also encompassed by the scope of the present invention as long as they still have the features of the present invention. Also, the elements of the embodiments described above and the modified examples (discussed below) can be combined to the extent that this is technically possible, and these combinations are also encompassed by the scope of the present invention as long as they still have the features of the present invention.

For example, in the first and second embodiments, a locked character confirmation button 106 is provided on the deck organization screen 80 shown in FIG. 8, and in steps SP2, SP3, and SP4 in FIGS. 6 and 12, as an example of an “operation to confirm the locked content 72A,” it has been explained that the player sets the first content 72 in the setting boxes 82, and then performs an operation of pressing (clicking or tapping) the first content 72 set in a setting box 82, and then performs an operation of pressing (clicking or tapping) the locked character confirmation button 106, thereby causing the locking unit 58 to lock the first content 72 in the setting box 82, but the locked character confirmation button 106 may not be provided on the deck organization screen 80, and the player may lock the first content 72 in the setting boxes 82 by clicking (tapping) the first content 72 set in the setting boxes 82 of the deck 104.

Also, this “operation to confirm the locked content 72A” may be performed without setting first content 72 in the setting boxes 82.

For example, if a player designates a first content 72 in the first content list 90 on the deck organization screen 80 shown in FIG. 8 (a first content 72 that has not yet been set in a setting box 82), and assigns an attribute such as “starting lineup” or “favorite,” the locking unit 58 sets that first content 72 as locked content 72A, and then, when that locked content 72A is set in the setting boxes 82 of the deck 104, the locked content 72A is locked to the setting boxes 82. The “designation” here may be performed by an operation of pressing (clicking or tapping) a setting box 82. This may instead be accomplished by an operation of first pressing (clicking or tapping) a setting box 82 and then pressing (clicking or tapping) the locked character confirmation button 106.

Alternatively, the player may designate a setting box 82 in which no first content 72 has been set, thereby changing that setting box 82 into a “locked box” (that is, changing the attributes of the setting box 82), and then, when the player sets first content 72 in that locked box, the first content 72 is locked to that locked box automatically. The “designation” here may be performed by an operation of pressing (clicking or tapping) a setting box 82. This may instead be accomplished by an operation of first pressing (clicking or tapping) a setting box 82 and then by an operation of pressing (clicking or tapping) the locked character confirmation button 106 (in this case, the name of the locked character confirmation button 106 is changed to “locked box confirmation button” or the like).

Alternatively, a dedicated locking button may be provided for each first content 72, and the locked content 72A may be determined by means other than manipulating the first content 72 or a setting box 82, and then when that locked content 72A is set in a setting box 82, the locked content 72A is locked to the setting box 82 automatically.

Also, in the first embodiment, a case was described in which the locking unit 58 locked the locked content 72A based on operations by the player, but if the locking unit 58 determines that the same first content 72 has continued to be set for a specific length of time (that is, if the player has continued to use it), the locking unit 58 may set that first content 72 as locked content 72A without any operation by the player.

Also, the processing performed by the organization unit 54 described in the first and second embodiments, and the locking of the second content 74 performed by the determination unit 64 and the locking unit 58 described in the first embodiment may also be performed without any operation by the player.

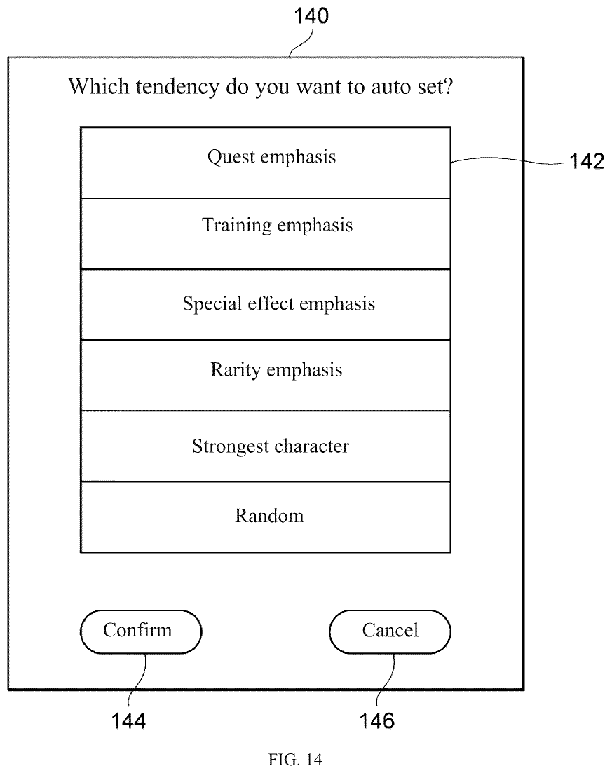

Also, in the first embodiment, an operation by the player to select the priority content 72B was described such that the player first pressed (clicked or tapped) the priority character selection button 108 on the deck organization screen 80 shown in FIG. 8, thereby causing the display control unit 52 to perform control for displaying the priority content selection screen 150 shown in FIG. 9, and the player determined the priority content 72B from this screen, but the priority character selection button 108 may not be provided on the deck organization screen 80 shown in FIG. 8 (and the priority content selection screen 150 shown in FIG. 9 may not be provided either), and when the player clicks (taps) the automatic setting button 96, the display control unit 52 may perform control for displaying the first content setting tendency decision screen 140 shown in FIG. 14.

The first content setting tendency decision screen 140 shown in FIG. 14 is provided with a tendency list 142, a confirmation button 144, and a cancel button 146.

The tendency list 142 displays several types of tendencies that occur in setting first content 72 other than the locked content 72A in the setting boxes 82 in steps SP10, SP29, SP41, and SP51. For example, “quest emphasis” is a setting that emphasizes first content 72 that matches the tendencies of the quest. “Development emphasis” is a setting that emphasizes first content 72 that the player wants to develop (whose level has not yet increased).

“Special effect emphasis” is a setting that emphasizes the special effect (efficacy) of the first content 72. As an example, emphasis may be placed on first content 72 that increases the number of rewards (items) that can be acquired when a quest is cleared, or on first content 72 that increases the damage inflicted on enemy characters in a quest.

“Rarity emphasis” is a setting in which emphasis is placed on the rarity (degree of rarity) of the first content 72.

As an example, first content 72 with a low rarity may be prioritized, or first content 72 with a high rarity may be prioritized, or, if rarity is expressed on a scale of ★1 to ★5, only first content 72 with ★3 may be prioritized, or only first content 72 with ★4 may be prioritized.

The “strongest character” is used to determine first content 72 by placing emphasis on the level and status. “Random” determines the first content 72 at random.

When the player performs an operation to select a tendency from the tendency list 142 and further performs an operation of clicking (tapping) the confirmation button 144, the organization unit 54 determines the first content 72 in steps SP10, SP29, SP41, and SP51 according to the tendency selected by the player from the tendency list 142. The cancel button 146 is used to cancel this selection, and when the player clicks (taps) the cancel button 146, the display control unit 52 may return to the deck organization screen 80 shown in FIG. 8.

Also, in the first embodiment, a case was described in which the locking unit 58 set some of the first content 72 set in the setting boxes 82 as locked content 72A based on operations by the player, but instead, of the first content 72 set in the setting boxes 82, the first content 72 that has been continuously set for a certain length of time may be automatically set as locked content 72A. Also, the locking unit 58 may suggest to the player that first content 72 that has been continuously set for a certain length of time, from among the first content 72 set in the setting boxes 82, be set as locked content 72A. Similarly, the locking unit 58 may automatically set the strongest first content 72, from among the first content 72 set in the setting boxes 82, as locked content 72A. Also, the locking unit 58 may suggest to the player that the strongest first content 72, from among the first content 72 set in the setting boxes 82, be set as locked content 72A.

Also, in the first embodiment, a case was described in which the removal unit 62 removed any first content 72 other than the locked content 72A from the setting boxes 82, but the locked content 72A may be removed either based on operations by the player or automatically once a certain length of time has elapsed. Also, the removal unit 62 may automatically remove the locked content 72A when the game is updated, or when the player comes to possess new first content 72 through a lottery or the like. This makes it less likely that the player will continue to use only the locked content 72A, which makes the game more entertaining.

Also, in the first and second embodiments, as shown in FIGS. 7 and 13, respectively, the processing in steps S22 to S32 was performed based on operations by the player after the player had determined on a quest in step SP21, but the configuration may instead be such that the deck 104 is automatically organized by the organization unit 54, depending on a quest when the player determines on the quest in step SP21 (here, the deck 104 that was automatically organized may be automatically recorded as the completed deck 76).

In addition, FIGS. 6 and 7 illustrate a case in which the player sets the priority content 72B in steps SP5 and SP6, and when the organization unit 54 sets (automatically sets) the first content 72 in the empty setting boxes 82 in steps SP10 and SP29, the priority content 72B is set preferentially, but the organization unit 54 may instead determine the first content 72 to be set in the setting boxes 82 depending on the game quest (difficulty level, tendencies, gimmicks, enemies that appear, etc.). For example, if a quest has a low level of difficulty, first content 72 (a character) that is in the process of being developed may be selected (this allows the first content 72 in the process of being developed to acquire experience points), and if a quest has a high level of difficulty, a strong first content 72 that has grown (has high parameters such as level) may be selected.

With this configuration, using the organized deck 104 makes it easier to complete a quest, and this motivates the player to play the game.

Also, in the first and second embodiments, it was described that a decision operation for determining the locked content 72A or the priority content 72B was performed by the player, but this may be automated by using some other technical assistance means.

More specifically, if there is no operation by the player, the locked content 72A and priority content 72B that were locked and set the last time the deck 104 was organized may continue to be locked and set in the setting boxes 82 of the deck 104 (by the locking unit 58 and the organization unit 54). Alternatively, the locking unit 58 and the organization unit 54 may automatically select, lock, and set the locked content 72A and the priority content 72B based on the player's past action history.

Also, in the first and second embodiments, it was described that the first content 72 was possessed by the player, but the first content 72 is not limited to this, and may instead be content that is temporarily loaned to the player. This may be, for example, rental content set by on the game management side for each quest, content rented by the player from a friend (content set for loan by the friend), or rental content provided when the player is lacking content. That is, the first content 72 may be any content available to the player (whether possessed or rented).

Also, in the first and second embodiments, an example was given of a game in which the aim was to clear a quest using a deck 104 that has been organized, but the type of game may instead be a player-versus-player battle game, or the like.

### REFERENCE SIGNS LIST

10 . . . server device (information processing device, computer), 12 . . . terminal device (information processing device, computer), 14 . . . game program (instructions), 54 . . . organization unit, 58 . . . locking unit, 62 . . . removal unit

What is claimed is:

1. A non-transitory computer readable recording medium storing instructions for organizing a deck comprising setting boxes in which first contents available to a player are respectively set, the instructions causing an information processing device to execute:
in response to a player operation, setting, as a locked content, at least one of the first contents in the setting boxes;
removing, from the setting boxes, any first contents other than the locked content set in the setting boxes;
setting first contents available to the player in the setting boxes from which the first contents have been removed to organize the deck; and
during a quest of a game, invoking the deck in response to a player operation and causing the player to use the first contents set in the deck.

2. A non-transitory computer readable recording medium storing instructions for organizing a deck comprising setting boxes in which first contents available to a player are respectively set, the instructions causing an information processing device to execute:
in response to a player operation, setting, as a locked content, at least one of the first contents in the setting boxes;
replacing any first contents other than the locked content with first contents available to the player in the setting boxes to organize the deck; and
during a quest of a game, invoking the deck in response to a player operation and causing the player to use the first contents set in the deck.

3. The non-transitory computer readable recording medium according to claim 1, wherein
the instructions cause the information processing device to further execute:
determining the first contents to be set in the setting boxes depending on the quest of the game.

4. The non-transitory computer readable recording medium according to claim 1, wherein
the instructions cause the information processing device to further execute:
in response to a player operation, determining a priority content from among the first contents available to the player, and preferentially selecting the priority content as a first content to be set in one of the setting boxes.

5. The non-transitory computer readable recording medium according to claim 1, wherein
the instructions cause the information processing device to further execute:
causing a display of a terminal device to display a list of completed decks each including at least one of the setting boxes in which the locked content has been set such that the setting boxes in which the locked contents have been set are displayed differently from the remaining setting boxes; and
setting, as a current deck:
upon detecting only one completed deck, the completed deck, and
upon detecting completed decks, a completed deck selected from the list in response to a player operation.

6. The non-transitory computer readable recording medium according to claim 1, wherein
the instructions cause the information processing device to further execute:
in response to a player operation, linking a second content to the locked content and to the first contents set in the setting boxes, and
locking, as the locked content, the second content linked to the locked content.

7. The non-transitory computer readable recording medium according to claim 6, wherein
the instructions cause the information processing device to further execute:
determining compatibility between the locked content and the second content, and
determining whether to lock the second content to the locked content based on the compatibility.

8. An information processing device that organizes a deck comprising setting boxes in which first contents available to a player are respectively set, the device comprising:
a hardware processor that:
in response to a player operation, sets, as a locked content, at least one of the first contents in the setting boxes;
removes, from the setting boxes, any first contents other than the locked content set in the setting boxes;
setting first contents available to the player in the setting boxes from which the first contents have been removed by the removal means to organize the deck; and
during a quest of a game, invokes the deck in response to a player operation and causes the player to use the first contents set in the deck.

9. An information processing device that organizes a deck comprising setting boxes in which first contents available to a player are respectively set, the device comprising:
a hardware processor that:
in response to a player operation, sets, as a locked content, at least one of the first contents in the setting boxes;
replacing any first contents other than the locked content with first contents available to the player in the setting boxes to organize the deck; and
during a quest of a game, invokes the deck in response to a player operation and causes the player to use the first contents set in the deck.
